(19) United States
(12) Patent Application Publication
(10) Pub. No.: US 2023/0267507 A1
(43) Pub. Date: Aug. 24, 2023

(54) GENERATING AND HANDLING OPTIMIZED CONSUMER SEGMENTS

(71) Applicant: CATALINA MARKETING CORPORATION, St. Petersburg, FL (US)

(72) Inventors: Wassim Samir CHAAR, Coppell, TX (US); Daniel William CROPSEY, Fox River Grove, IL (US); Talia Erin STRAIT, Chicago, IL (US); Adam Peter Frank DRINI, Roswell, GA (US)

(21) Appl. No.: 18/014,120

(22) PCT Filed: Jul. 1, 2021
(86) PCT No.: PCT/US2021/040208

§ 371 Date: Dec. 30, 2022

Related U.S. Application Data
(60) Provisional application No. 63/047,540, filed on Jul. 2, 2020.

(51) Int. Cl. G06Q 30/0251; G06Q 30/0204; G06Q 30/0272

(52) U.S. Cl. CPC G06Q 30/0269; G06Q 30/0204; G06Q 30/0261; G06Q 30/0272

(57) ABSTRACT

A method for generating and handling optimized consumer segments is provided. The method includes receiving, in a server, a raw data from consumer devices, refining the raw data to capture a data pattern, and predicting a consumer behavior based on the data pattern, the consumer behavior defining attributes. The method also includes identifying a consumer segment based on the consumer behavior and a sharing of a one or more attributes among multiple consumers in the consumer segment, selecting at least one of an advertising message or a promotional offer to one or more consumers in the consumer segment to include in a payload content, identifying a media channel to deliver the payload content to one or more consumer devices, and providing the consumer segment to a display. A system and a non-transitory, computer-readable medium storing instructions to perform the above method are also provided.

### CROSS-REFERENCE TO RELATED APPLICATIONS

The present disclosure is related and claims priority under 35 U.S.C. 119(e) to U.S. Prov. Pat. Appln. No. 63/047,540, entitled GENERATING AND HANDLING OPTIMIZED CONSUMER SEGMENTS, filed on Jul. 2, 2020, to Wassim Chaar, et-al., the contents of which are hereby incorporated by reference in their entirety, for all purposes.

### BACKGROUND

### Field

The present disclosure relates to generating targeted promotions and advertisements to consumer segments selected to have as an example, a high return on advertising spend (ROAS) impact, or other key performance indicators (KPI). More specifically, methods and systems as disclosed herein provide optimized consumer segments for targeted product campaigns based on real-time data collection from multiple consumers in a network.

### Description of Related Art

Current trends in the industry point to the goal of personalized advertising where each consumer receives a custom advertisement or offer for a product based on a personal purchasing history. However, certain media channels may be better suited for groups or blocks of consumers (e.g., “consumer segments”), such as a mobile app, connected TV, and desktop display. Moreover, the ROAS achieved by suitably selected consumer segments delivered in right media context typically surpasses that of mass market advertising or even those targeted to specific consumers without regard to the media.

### SUMMARY

In a first embodiment, a computer-implemented method includes receiving, in a server, a raw data from multiple consumer devices, refining the raw data to capture a data pattern, and predicting a consumer behavior based on the data pattern, the consumer behavior defining one or more attributes. The computer-implemented method also includes identifying a consumer segment based on the consumer behavior and a sharing of a one or more attributes among multiple consumers in the consumer segment, and selecting at least one of an advertising message or a promotional offer to one or more consumers in the consumer segment to include in a payload content. The computer-implemented method also includes identifying a media channel to deliver the payload content to one or more consumer devices, and providing the consumer segment to a display in a client device, upon request.

In a second embodiment, a system includes a data acquisition layer configured to test, standardize, partition and format a raw data received by a server. The system also includes a data enrichment tool, configured to refine the raw data by transformation, feature computation, and training of an auxiliary model to capture a data pattern in the raw data, a targeting imputation tool configured to impute one or more consumer attributes to define a target audience and a consumer segment, and a consumer preference tool storing multiple consumer preferences for multiple products or brands and multiple consumer sensitivities for marketing impulses. The system also includes a behavior prediction tool configured to predict a consumer behavior based on the consumer preferences for products and the marketing impulses, and an application layer configured to provide a payload content to a consumer device, the payload content including a personalized advertisement or coupon for a selected product or brand based on the consumer behavior.

In a third embodiment, a non-transitory, computer-readable medium storing instructions which, when executed by a processor, cause a computer to execute a method. The method includes receiving, in a server, a raw data from multiple consumer devices, refining the raw data to capture a data pattern, and predicting a consumer behavior based on the data pattern, the consumer behavior defining one or more attributes. The method also includes identifying a consumer segment based on the consumer behavior and a sharing of a one or more attributes among multiple consumers in the consumer segment, selecting an advertising message or promotional offer to one or more consumers in the consumer segment to include in a payload content, identifying a media channel to deliver the payload content to one or more consumer devices, and providing the consumer segment to a display in a client device, upon request.

In yet another embodiment, a system includes a means for storing instructions, and a means for executing the instructions which causes the system to perform a method. The method includes receiving, in a server, a raw data from multiple consumer devices, refining the raw data to capture a data pattern, and predicting a consumer behavior based on the data pattern, the consumer behavior defining one or more attributes. The method also includes identifying a consumer segment based on the consumer behavior and a sharing of a one or more attributes among multiple consumers in the consumer segment, selecting at least one of an advertising message or promotional offer to one or more consumers in the consumer segment to include in a payload content, identifying a media channel to deliver the payload content to one or more consumer devices, and providing the consumer segment to a display in a client device, upon request.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates a system for providing optimized consumer segments, according to some embodiments.

FIG. 2 illustrates details of exemplary devices used in one embodiment of the architecture of FIG. 1, according to some embodiments.

FIG. 3 illustrates details of exemplary devices used in a second embodiment of the architecture of FIG. 1, according to some embodiments.

FIG. 4 illustrates a schematic representation of different consumer segments in a consumer universe, according to some embodiments.

FIGS. 5A-5B illustrate screenshots of an application to generate and handle consumer segments in a client device, according to some embodiments.

FIGS. 6A-6B illustrate screenshots of an application to discover and handle consumer segments in a client device, according to some embodiments.

FIG. 7 illustrates a screenshot of a segment import widget in an application to generate and handle consumer segments in a client device, according to some embodiments.

FIG. 8 illustrates a screenshot of a segment profiling widget in an application to generate and handle consumer segments in a client device, according to some embodiments.

FIG. 9 illustrates a screenshot of a sub-segment profiling widget in an application to generate and handle consumer segments in a client device, according to some embodiments.

FIG. 10 illustrates a graphic display of a consumer segment profile in an application to generate and handle consumer segments in a client device, according to some embodiments.

FIG. 11 is a flow chart illustrating steps in a method for providing a consumer segment based on raw data input from multiple consumers, according to some embodiments.

FIG. 12 is a flow chart illustrating steps in a method for providing an advertising campaign for a product or item for sale, according to some embodiments.

FIG. 13 is a block diagram illustrating an example computer system with which the client and server of FIGS. 1 and 2 and the methods of FIGS. 11 and 12 can be implemented, according to some embodiments.

In the figures, elements and steps denoted by the same or similar reference numerals are associated with the same or similar elements and steps, unless indicated otherwise.

### DETAILED DESCRIPTION

In the following detailed description, numerous specific details are set forth to provide a full understanding of the present disclosure. It will be apparent, however, to one ordinarily skilled in the art, that embodiments of the present disclosure may be practiced without some of these specific details. In other instances, well-known structures and techniques have not been shown in detail so as not to obscure the disclosure.

The present disclosure provides an environment and a network architecture that enables the gathering of real-time consumer data from a broad network using existing infrastructure (e.g., retailer point of sales and media advertising networks). In addition, network architectures as disclosed herein include data processing and filtering modules, which when combined with artificial intelligence, machine learning, and other nonlinear algorithms (e.g., neural networks) and mathematical modeling, enable the selection of consumer segments for targeted promotional campaigns. Embodiments as disclosed herein also apply machine learning, artificial intelligence algorithms, and mathematical modeling to optimize the consumer segments and improve the effect of the promotional campaign based on real-time purchasing data obtained from multiple channels including consumers and retailers.

### General Overview

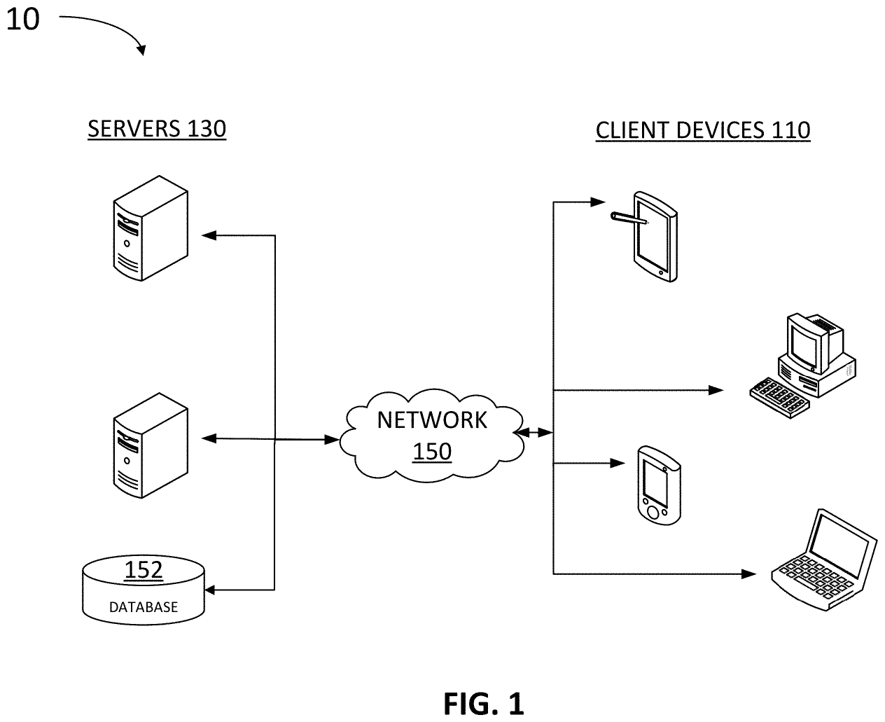

FIG. 1 illustrates an architecture in a system 10 for providing optimized consumer segments, according to some embodiments. System 10 includes servers 130, client devices 110, and at least one database 152, communicatively coupled with each other through a network 150. Servers 130 and client devices 110 have a memory, including instructions which, when executed by a processor, cause servers 130 and client devices 110 to perform at least some of the steps in methods as disclosed herein. In some embodiments, system 10 is configured to present personalized digital promotions to a consumer, who may be the user of one or more client devices 110. A targeted advertisement payload may be retrieved from a purchase history of the consumer, which may be stored in a history log in a memory of the server. In some embodiments, a user of one of client devices 110 is an advertising agent accessing a consumer insight engine in a server 130 to design and execute an advertising campaign on behalf of a brand manufacturer, or a retail store. In some embodiments, the user of one of client devices 110 may include the brand manufacturer or the retail store itself.

Servers 130 and database 152 may include any device having an appropriate processor, memory, and communications capability for hosting a history log of purchasing data, an advertisement database, and a consumer insight engine. The consumer insight engine may be accessible by various client devices 110 over network 150. In some embodiments, servers 130 may include a dynamic creative rendering server, a publisher, or supply side platform (SSP) server, and a demand side platform (DSP) server. Client devices 110 may include, for example, desktop computers, mobile computers, tablet computers (e.g., including e-book readers), mobile devices (e.g., a smartphone or PDA), or any other devices having appropriate processor, memory, and communications capabilities for accessing the image search engine and the history log on one or more of servers 130. Network 150 may include, for example, any one or more of a local area network (LAN), a wide area network (WAN), the Internet, and the like. Further, the network can include, but is not limited to, any one or more of the following network topologies, including a bus network, a star network, a ring network, a mesh network, a star-bus network, tree or hierarchical network, and the like.

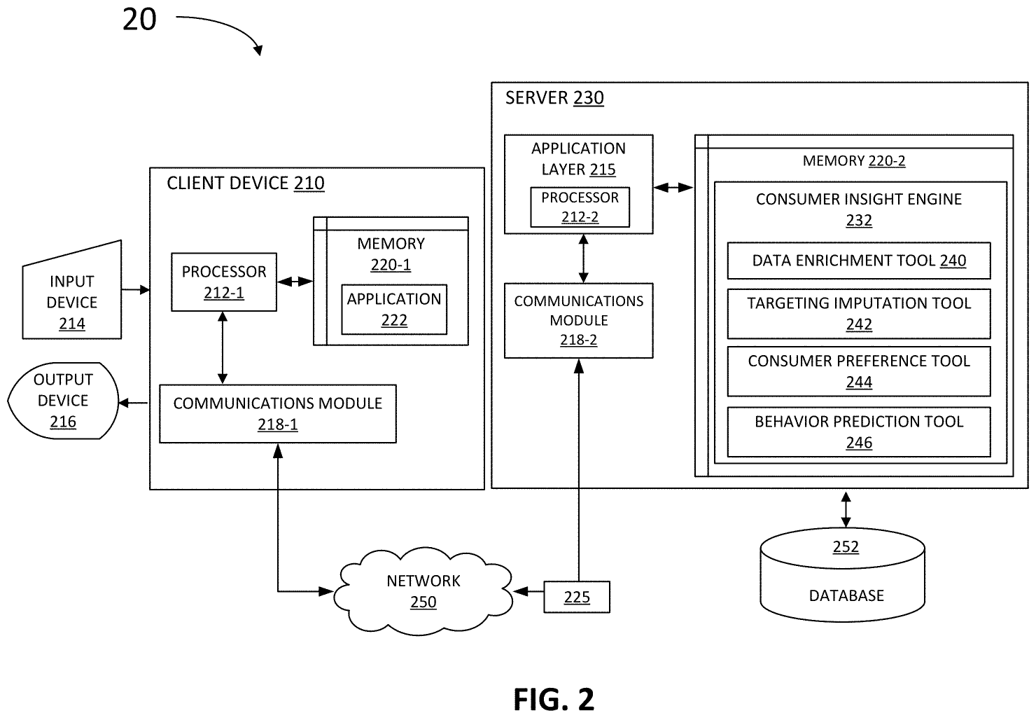

FIG. 2 illustrates details of exemplary devices used in one embodiment of a system 20, according to some embodiments. A client device 210, a server 230, and a database 252 are communicatively coupled over a network 250 (cf. client devices 110, servers 130, database 152, and network 150) via respective communications modules 218-1 and 218-2 (hereinafter, collectively referred to as “communication modules 218”). Communications modules 218 are configured to interface with network 250 to send and receive information, such as data, requests, responses, and commands to other devices on network 250. In some embodiments, communications modules 218 can be, for example, modems or Ethernet cards. Client device 210 may be coupled with an input device 214 and with an output device 216. Input device 214 may include a keyboard, a mouse, a pointer, or even a touch-screen display that a user (e.g., a consumer) may utilize to interact with the client device. Likewise, output device 216 may include a display and a speaker with which the user may retrieve results from client device 210.

Client device 210 may also include a processor 212-1 configured to execute instructions stored in a memory 220-1, and to cause client device 210 to perform at least some of the steps in methods consistent with the present disclosure. Memory 220-1 may further include an application 222 storing specific instructions which, when executed by processor 212-1, cause a data payload 225 from server 230 to be displayed for the user of client device 210. Data payload 225 may include an advertisement payload to be displayed for the consumer, or a consumer segment displayed to an advertising agent planning an advertisement campaign. Application 222 may be installed by and perform scripts and other routines provided through an application layer 215 in server 230. Application layer 215 includes a processor 212-2 configured to execute instructions stored in a memory 220-2. In some embodiments, a consumer, having a frequent shopper identification or not, may download application 222 from an “online store” of a retailer, or a brand manufacturer. The advertisement payload may include advertising messages or multiple digital promotions or coupons presented to the consumer by the server, and the consumer may store at least some of the digital promotions or coupons from the advertisement payload in memory 220-1. The consumer segment may include a list of consumer IDs and a description of consumer attributes associated with the consumer segment. In some embodiments, application 222 includes instructions which, when executed by processor 212-1, cause a display in output device 216 to display a portal of a consumer insight engine 232 hosted by server 230. Accordingly, application 222 may include instructions, which when executed by processor 212-1, cause an output device 216 to display a consumer segment optimized for a targeted advertisement campaign. Moreover, in some embodiments, application 222 may include instructions which, when executed by processor 212-1, cause client device 210 to store the consumer segment in memory 220-1, or in database 252.

Server 230 includes a memory 220-2, a processor 212-2, and communications module 218-2. Processor 212-2 is configured to execute instructions, such as instructions physically coded into processor 212-2, instructions received from software in memory 220-2, or a combination of both. Memory 220-2 includes a consumer insight engine 232 configured to define and refine consumer attributes, and predict consumer behavior based on the consumer attributes. In some embodiments, consumer insight engine 232 identifies, stores, and updates multiple, non-intersecting consumer segments, each consumer segment having selected consumer attributes. Consumer insight engine 232 is configured to identify, define, and refine the consumer attributes in different consumer segments based on real-time purchasing data retrieved from client device 210, through network 250. In this regard, client device 210 may be a smartphone or other mobile device used by a consumer at the time of purchasing a brand product or item (e.g., at a retail store). In some embodiments, client device 210 may include a computer or any other network connected device at the point of sale (POS) in a retail store. In yet other embodiments, client device 210 may include a server or centralized computer in a retail store server, providing real-time purchasing data to server 230 hosting consumer insight engine 232. Consumer insight engine 232 may include a data enrichment tool 240, a targeting imputation tool 242, a consumer preference tool 244, and a behavior prediction tool 246.

Data enrichment tool 240 acquires raw consumer data either in batches, or in real-time, and applies transformations and filters to the raw data. In some embodiments, data enrichment tool 240 captures and identifies data patterns that may be handled by an artificial intelligence or machine learning tool.

Targeting imputation tool 242 imputes consumer attributes used for defining target audiences and consumer segments. Consumer preference tool 244 identifies a consumer preference for a brand product or item. In some embodiments, consumer preference tool 244 also determines consumer sensitivity to marketing impulses. For example, consumer preference tool 244 may determine a change in consumer preference based on the pricing of a product or item. Behavior prediction tool 246 determines a probability of consumer purchase of an item. With behavior prediction tool 246, consumer insight engine 232 may be able to predict incremental effects in purchasing incidence, revenue, and profit, of selected marketing actions (e.g., campaigns, offers, and the like). In some embodiments, targeting imputation tool 242, consumer preference tool 244, and behavior prediction tool 246 may include a neural network model, or any nonlinear or linear regression algorithm to perform data correlations and to associate values to and ascertaining a distance measure between semantic concepts and textual descriptions such as consumer attributes and branded product attributes.

Application layer 215 produces the output of consumer insight engine 232 in the form of a data payload 225 including advertisement payloads, coupons, offers, and the like, through different media channels to consumers. In some embodiments, data payload 225 includes a list of consumer IDs provided to an advertising agent, a brand manufacturer, or a retail store. The consumer IDs in the list may be classified according to one or more consumer segments, defined by consumer attributes. Accordingly, in some embodiments, the output from application layer 215 is a document including a statistical analysis, charts, and an explanation of the consumer segments and other predicted market insights.

Consumer insight engine 232 selects optimized consumer segments based on raw data retrieved from client device 210 (e.g., a smart phone used by a consumer at a time of purchase, or a computer from a POS at a retail store or centralized server thereof). In some embodiments, consumer insight engine 232 may retrieve the raw data, or the refined data, from database 252, including consumer purchasing history, product sales history, or retail store sales history. In yet other embodiments, consumer insight engine 232 may retrieve raw data or the refined data from a server in a retail store, or a server hosted by a brand manufacturer.

In one or more implementations, database 252 may include a list of frequent consumers of the retailer. The consumers may have a frequent shopper identification associated with a retailer. In some embodiments, in addition to one or more “brick and mortar” physical locations of stores for the retailer, the retailer may host an online shopping outlet hosted by a network server (e.g., server 230). Server 230 may create, update, and maintain database 252, including frequent shopper identifications and purchase history logs. In that regard, database 252 may be hosted by the retailer or a brand manufacturer, while consumer insight engine 232 may be hosted by a DSP server or a dynamic creative rendering server. Accordingly, the DSP server may have access to one or more databases 252, through business agreements with one or more retailers or product manufacturers. In certain aspects, processor 212-2 in a server 230 hosted by a retailer may be configured to determine data for database 252 by obtaining consumer purchasing data identifying the consumer via the frequent shopper identification used at multiple purchasing events in multiple locations, over a pre-selected span of time. Processors 212-1 and 212-2, and memories 220-1 and 220-2 will be collectively referred to, hereinafter, as “processors 212” and “memories 220,” respectively.

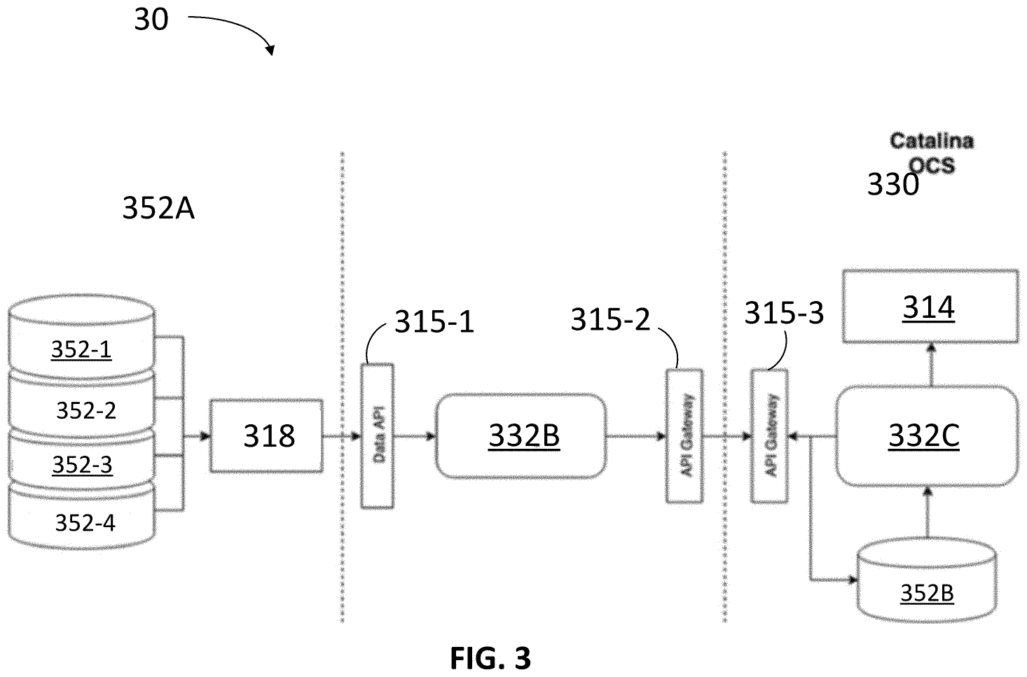

FIG. 3 illustrates details of exemplary devices used in a system 30, according to some embodiments. System 30 includes raw data sources 352A, an engine 332B, and an optimized consumer segment (OCS) server 330. Engine 332B delivers data and computational output used by an OCS frontend 314 to display content to the user. In some embodiments, engine 332B may be deployed within server 330.

Raw data sources 352A may include a transactional line item database 352-1, a consumer metadata database 352-2, a media exposure database 352-3, and a product metadata database 352-4 (hereinafter, collectively referred to as “databases 352”). A data export and mapping tool 318 interfaces with a data API 315-1 coupled with engine 332B, to provide the data in databases 352. Engine 332B imports data through data API 315-1 such as transactional line item data, consumer metadata, media exposure data, and product master data.

An API gateway 315-2 interfaces with API gateway 315-3 to transmit data between engine 332B and OCS server 330 (APIs 315-1, 315-2, and 315-3 will be collectively referred to, hereinafter, as “APIs 315”). OCS server 330 includes an OCS engine 332C, which stores and accesses data from OCS database 352B and is coupled with OCS frontend 314 to interact with a user (engines 332B and 332C will be collectively referred to, hereinafter, as “engines 332”). Engines 332 may access shopper purchase transactions, media, and dimensional data in its native location once deployed. Other OCS data including audience universe and resulting optimized segments may reside in server 330 (e.g., database 352B).

In some embodiments, engine 332B receives from server 330 the following information and requests: Ad ID (with associated Product IDs), Impact Goals, Consumer Segment Universe, Media Channel Accordingly, engine 332B outputs through APIs 315: a Ranked list of Consumer IDs including consumer attributes and media channels according to the Impact Prediction; an Ad ID (with associated Product IDs), an absolute change in purchase propensity caused by ad for each consumer; and aggregated overview of media channels.

Server 330 uses the output from Engine 332B to select the requested number of consumers available in the selected media channels. For these consumers, engine 332C computes the average Impact Prediction across consumers and uses consumer attributes for sub-segmenting and profiling. Software used by server 330, including APIs 315 are security tested and code scanned per security policies established and updates by server 330.

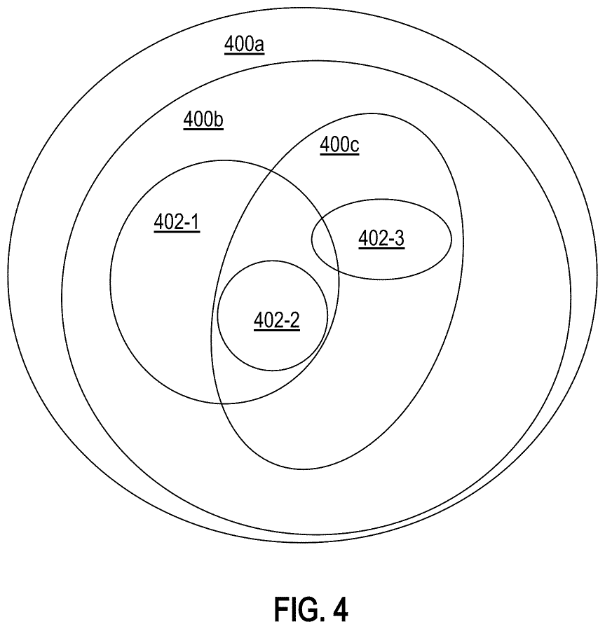

FIG. 4 illustrates a schematic representation of different consumer segments 402-1, 402-2, and 402-3 (hereinafter, collectively referred to as “consumer segments 402”) in a consumer universe 400a, 400b, or 400c (hereinafter, collectively referred to as “selected consumer universe 400”), according to some embodiments. A selected consumer universe 400 may be, for example, all the consumers in the US (e.g., consumer universe 400a), of which all consumers with attributes (e.g., consumer universe 400b) may be a subset. A consumer universe 400c may be more restrictive, including an advertisement campaign objective. In some embodiments, selected consumer universe 400 is a consumer selection based on past purchase behavior of consumers, e.g., consumers who have not bought the promoted brand before. An advertisement campaign objective is set by the advertiser for an advertisement campaign. In some embodiments, an objective translates into a pre-set configuration of selected consumer universe 400 and an impact goal. For example: “Try me” as input parameter in a campaign defines selected consumer universe 400 as all consumers who have not purchased the promoted products before, and the impact goal may be to increase “Unit Sales.” In some embodiments, an impact goal is an objective function for (financial) impact, that can be measured by descriptive or inferential statistics. Example: Return On Ad Spend (ROAS). In some embodiments, advertisement campaigns and consumer segments 402 may be ranked according to the predicted effect on this Impact Goal.

Consumer segments 402 straddle a cross section of one or more of selected consumer universes 400 (wherein consumer universe 400a encompasses all consumer segments 402). For example, consumer segment 402-1 may include consumers with purchasing attributes stored in one or more databases in the system. Of this consumer segment 402-1, a consumer segment 402-2 may include those consumers that, in addition to having purchase attributes registered in one or more databases accessible to a server, are also part of an advertisement campaign objective (e.g., consumer universe 400c). When a first consumer segment is fully embedded within a second consumer segment, then the first consumer segment may be referred to as a “sub-segment” of the second consumer segment.

Consumer segment 402-3 may include a campaign look-alike segment including attribute only consumers that behave similarly to core segment consumers that are “observed” or tracked by the OCS server (cf. OCS server 330).

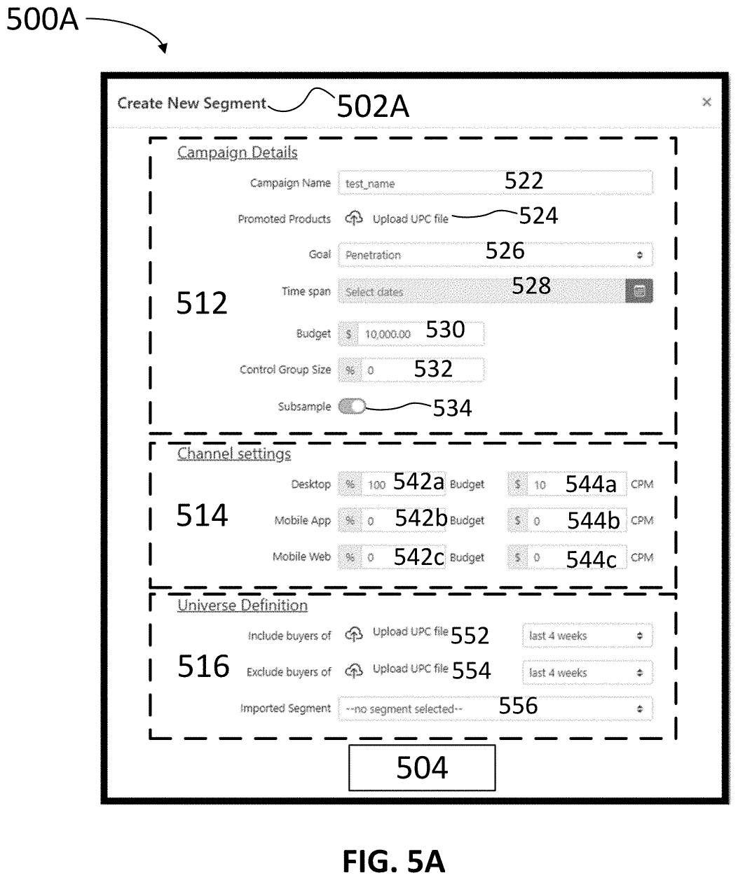

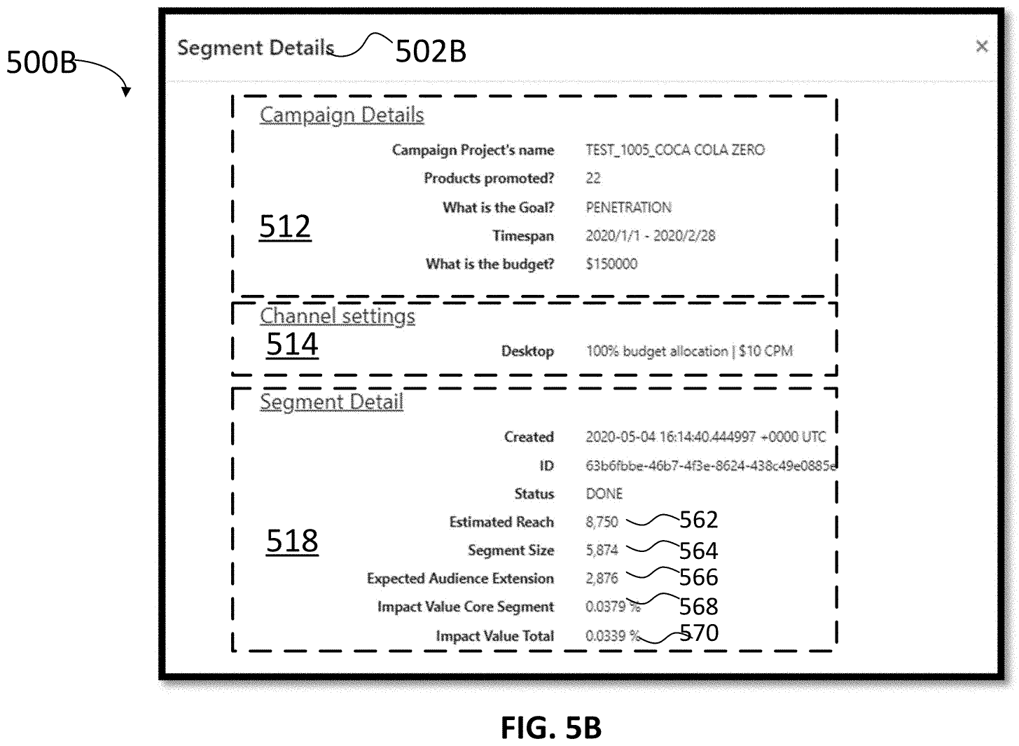

FIGS. 5A and 5B illustrate fields 500A and 500B (hereinafter, collectively referred to as “fields 500”) respectively, displayed by an application in a client device (e.g., application 222 and client devices 110 and 210), hosted by a server including a consumer insight engine, according to some embodiments. The application may be accessed by an advertising agent, a retail store, or a brand manufacturer, to determine one or more households or consumer groups to drive a high impact score in an advertising campaign. The advertising campaign may be based on a group of products identified by universal product codes (UPCs). The application may also allow the user to establish an objective for the advertising campaign, and other aspects of the campaign such as time length. Other options that the application may offer to the user include ROAS or Penetration Gain objectives.

FIG. 5A illustrates field 500A with an input field 502A in an application hosted by a system for providing optimized consumer segments in an advertising campaign, according to some embodiments. Input field 502A may include a prompt for campaign details 512, for channel settings 514, and for a universe definition 516. Input field 502A may also include a discover segment button 504 that the user activates so that the consumer insight engine applies the parameters input field 502A to find consumer segments accordingly.

Campaign details 512 may include a campaign name 522 and a list of promoted products 524 (selected using UPCs). Campaign details 512 may also include a campaign goal 526, which may be expressed in terms of a penetration depth (e.g. , market share of the advertised product, and the like), a time span for the campaign 528, a budget 530, and a selected size for the control group 532. The control group may be a selected set of consumers who may be kept out of the campaign, whose behavior, compared with the test group, may serve as an indication of the campaign impact: success, or lack thereof.

In some embodiments, a sub-sampling toggle 534 is included. When consumer-selection returns more than 100,000 household IDs, then the user may activate sub-sampling toggle 534 to initiate a random subsample of 100,000 household IDs from the consumer-selection result for further processing as the universe in the workflow. When the universe is smaller than 100,000, then the universe is fully used to be processed further. Additionally, when 100,000 households are selected randomly, the share of the sampled universe over the consumer-selection result is calculated to down-sample budget 530, accordingly. In some embodiments, sub-sampling toggle 534 is selected to obtain fast results (within <15 minutes) for ad campaign evaluation. In some embodiments, sub-sampling toggle 534 is de-activated to get the final production Segment file with all household IDs (which may take up to 48 hours to create, or more). For example, in some embodiments, a scenario may include a %400,000 budget 530 with a consumer selection result of 2,000,000. A sample universe of 100,000 household IDs may be randomly selected from the 2,000,000 consumer selection. The share of sample universe over consumer selection is 100,000/2,000,000=0.05 (5%). Accordingly, the sample budget is 400,000*0.05=20,000.

Channel settings 514 may include the types of channels used to reach out to the customers during the campaign, and the allocated budgets. This may include digital advertising through any one of the client devices disclosed herein, e.g., a desktop computer 542a, or a mobile computer. In some embodiments, a mobile computer channel may include two separate channels: an application channel (“mobile app”) 542b and web browser channel (“mobile web”) 542c (hereinafter, collectively referred to as “delivery channels 542”). In some embodiments, each of the channels may have a dedicated budget, 544a, 544b, and 544c, respectively (hereinafter, collectively referred to as “budgets 544”), as desired by the campaign designer.

Universe definition 516 offers the user the option to include 552 or exclude 554 specific consumers within a targeted segment of the advertising campaign. In some embodiments, the application may allow the user to import 556 a pre-built segment as the base universe. The universe definition may also include attributes such as consumer IDs that have been active or uploaded for a recent period of time (e.g., 4 weeks and the like).

FIG. 5B illustrates field 500B with an output field 502B in an application hosted by a system for providing an optimized consumer segment in an advertising campaign, according to some embodiments. The output field may include segment details with some of the campaign details 512 and channel settings 514 provided by the user as input. A segment detail field 518 may include the results of the segmentation process, including an estimated reach 562 (e.g., number of consumers that will be targeted), and the size 564 of a specific segment within the reach. The segment may be identified with a specific code. Given estimated reach 562 and segment size 564, an expected audience extension 566 indicates a number of consumers that may be added to the consumer segment. An impact value core segment 568 and an impact value total 570 includes predicted increases in revenue (e.g., sales) relative to the control group (e.g., assuming no campaign is conducted).

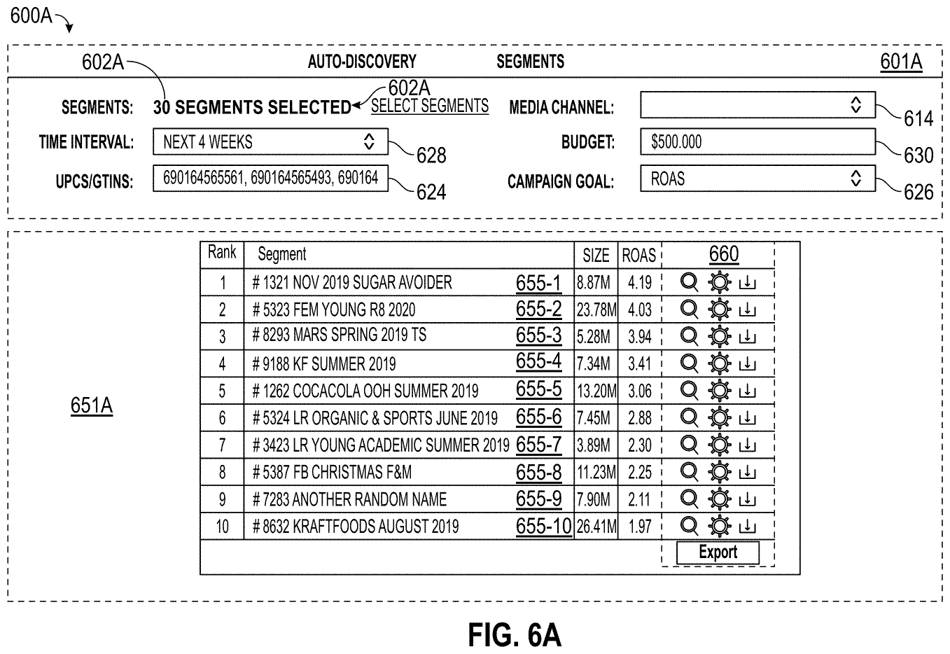

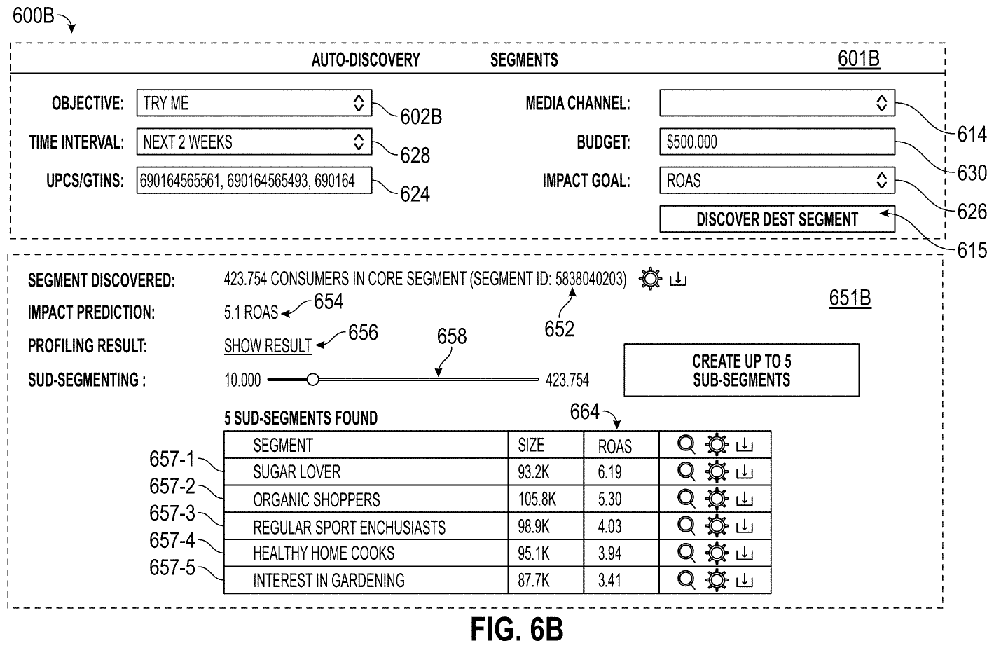

FIGS. 6A-6B illustrate screenshots 600A and 600B (hereinafter, collectively referred to as “screenshots 600”) of an application to discover and handle consumer segments in a client device (e.g., application 222 and client devices 110 and 210), according to some embodiments.

FIG. 6A illustrates a screenshot 600A including a summary field 601A indicating a number of segments 602A found during the discovery, a media channel 614, a budget 630, and a campaign goal 626. A time interval 628 selected for the campaign is also indicated (e.g., ‘next 4 weeks,’ ‘1 month,’ and the like), and a list 624 of UPCs and GTINs for the items or products included in the campaign.

A list field 651A lists one by one the different segments found, 655-1, 655-2, 655-3, 655-4, 655-5, 655-6, 655-7, 655-8, 655-9, and 655-10, hereinafter, collectively referred to as “discovered segments 655.” A download and export field 660 in list field 651A enables the user to download, save, or export each of discovered segments 655 to a selected memory or database (e.g., database 252). Discovered segments 655 can be exported as a list of consumer IDs (CSV file). The export process to generate the full consumer ID CSV file may be processed asynchronously as the time to generate takes time depending on the segment size. Some embodiments provide the ability to save discovered segments 655 and to import discovered segments 655 from external sources. Discovered segments 655 may be stored as lists of consumer IDs. The import feature enables loading predefined segments which are currently used and/or already stored on third party systems.

FIG. 6B illustrates a screenshot 600B with detailed information of one of the consumer segments in list field 651A. Screenshot 600B includes a summary field 601B indicating an objective 602B, media channel 614, budget 630, and impact goal 626. Time interval 628 selected for the campaign is also indicated (e.g., ‘next 2 weeks,’ 4 weeks,' ‘1 month,’ and the like), and list 624 of UPCs and GTINs for the items or products included in the campaign. A best segment button 615 triggers the server to select the best segment found in the discovery operation, according to the selected parameters (e.g., impact goal 626).

A list 651B includes sub-segments of the best segment identified by a segment ID 652, based on an impact prediction 654. A sub-segmenting feature as disclosed herein takes saved segments as an input and outputs multiple sub-segments that are defined by unique purchasing profile behavior and/or externally provided consumer attributes (or combinations of attributes). The purpose of these sub-segments is to isolate and cluster common consumer traits and behaviors that can be helpful in personalizing campaign creatives or selecting the most appropriate media by sub-segment. Consumer sub-segments can be profiled separately to understand their defining characteristics. Consumer sub-segments will typically not take up 100% of the original segment. A user can optionally define the minimum and maximum consumer number of the sub-segments to be found as well as the minimum size of each sub-segment. Default values for these parameters may be established. The resulting sub-segments can each be saved as separate consumer segments for further export or comparison purposes.

The user may select a profiling result 656, and a sub-segmentation slide 658 is also provided. Accordingly, the user may desire to look for sub-segments of the total consumer segment size (e.g., 423,754) having approximately a selected size (e.g., 100,000 consumers). Accordingly, list 651B includes sub-segments 657-1, 657-2, 657-3, 657-4, and 657-5 (hereinafter, collectively referred to as “sub-segments 657”). Sub-segments 657 may have a varying size around 100,000 consumers, with a varying impact value 664. Sub-segments 657 may be labeled according to some relevant attributes of the consumers therein (“sugar lover,” organic shoppers,” “regular sports enthusiasts,” “healthy home cooks,” and “interest in gardening”).

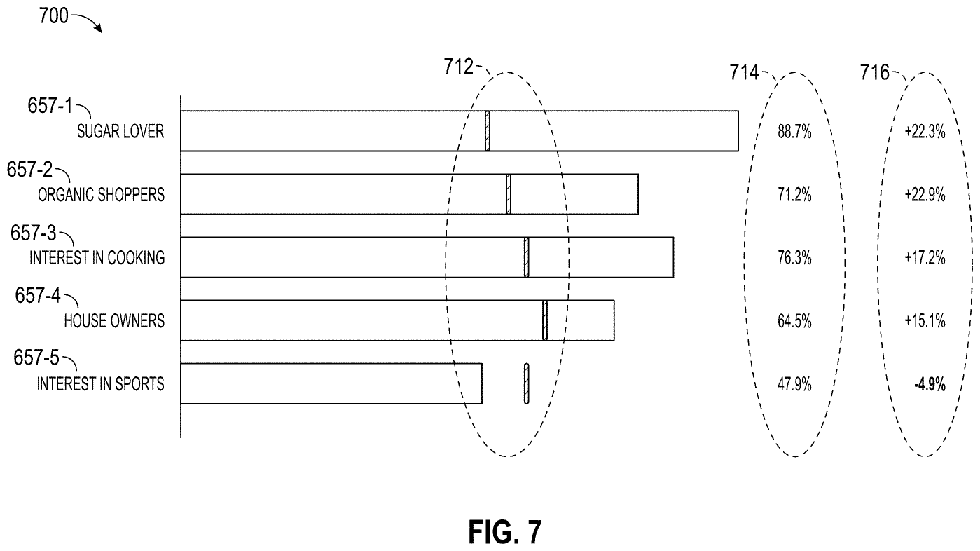

FIG. 7 illustrates a graphic display of a consumer segment profile 700 in an application to generate and handle consumer segments in a client device (e.g., application 222 and client devices 110 and 210), according to some embodiments. Profiling can be applied on a single consumer segment. Consumer segment profile 700 reveals common characteristic traits of the consumer segment according to the available attributes and perhaps unique purchasing behavior (if this purchase behavior is reflected in pre-computed attributes). In some embodiments, the characteristic traits may be derived from sub-segments 657. This helps to create a meaningful name for a given consumer segment and helps the client determine the best creative or media for each sub-segment.

Consumer segment profile 700 may include sub-segments 657 and a graphical plot of the percentage 714 of the consumers of a given sub-segment within the segment. Consumer segment profile 700 also includes an average percentage 712 of the consumer in the given sub-segment within the consume universe. A difference 716 between the average value within the segment and within the universe gives a profile of the segment.

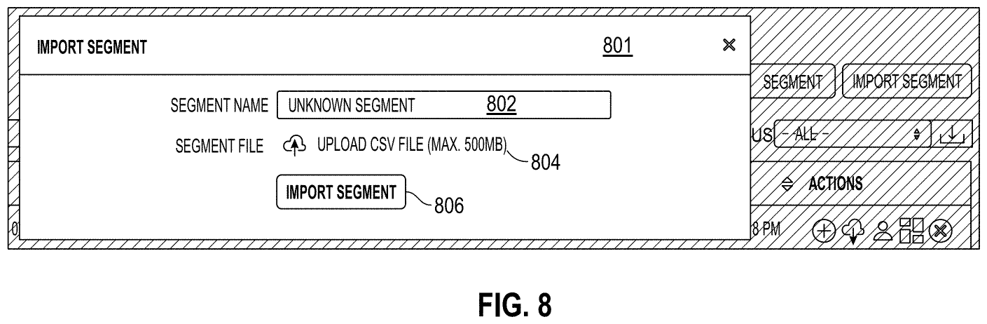

FIG. 8 illustrates a screenshot 800 of a segment import widget 801 in an application to generate and handle consumer segments in a client device (e.g., application 222 and client devices 110 and 210), according to some embodiments. Segment import widget 801 may include a segment name 802 and an option 804 to select a file where the segment data may be retrieved (e.g., in a remote database, and the like). Once the segment is named, import segment button 806 loads the segment to the current workload for the user. In some embodiments, the user enters the segment name 802 as a query and the server searches through one or more databases for a segment file associated with the requested consumer segment.

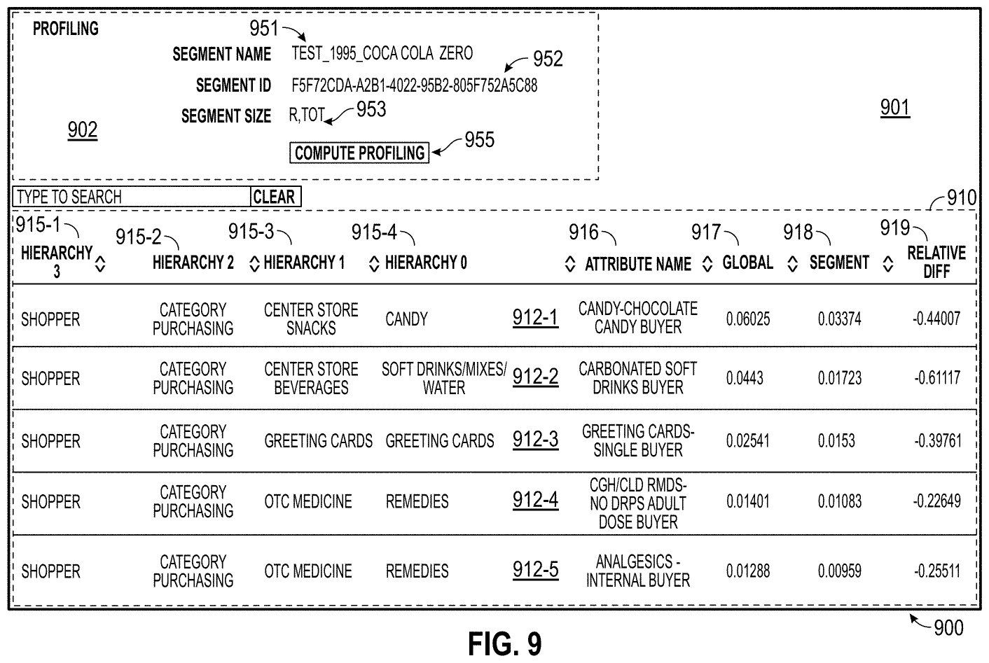

FIG. 9 illustrates a screenshot 900 of a segment profiling widget 901 in an application to generate and handle consumer segments in a client device (e.g., application 222 and client devices 110 and 210), according to some embodiments. Segment profiling widget 901 includes a metadata field 902, indicating a segment name 951, a segment ID 952, a segment size 953, and a button 955 to compute the segment profiling. A results field 910 lists different attributes 912-1, 912-2, 912-3, 912-4, and 912-5 (hereinafter, collectively referred to as “attributes 912”).

Results field 910 may include different hierarchies 915-1, 915-2, 915-3, and 915-4 (hereinafter, collectively referred to as “attribute hierarchies 915”), a name 916, a global weight 917, a segment weight 918, and a relative difference 919, for each of attributes 912. Global weight 917 indicates a proportion of the consumer universe sharing a given attribute. Segment weight 918 indicates a proportion of the consumer segment sharing the given attribute. Relative difference 919 is the difference between global weight 917 and segment weight 918.

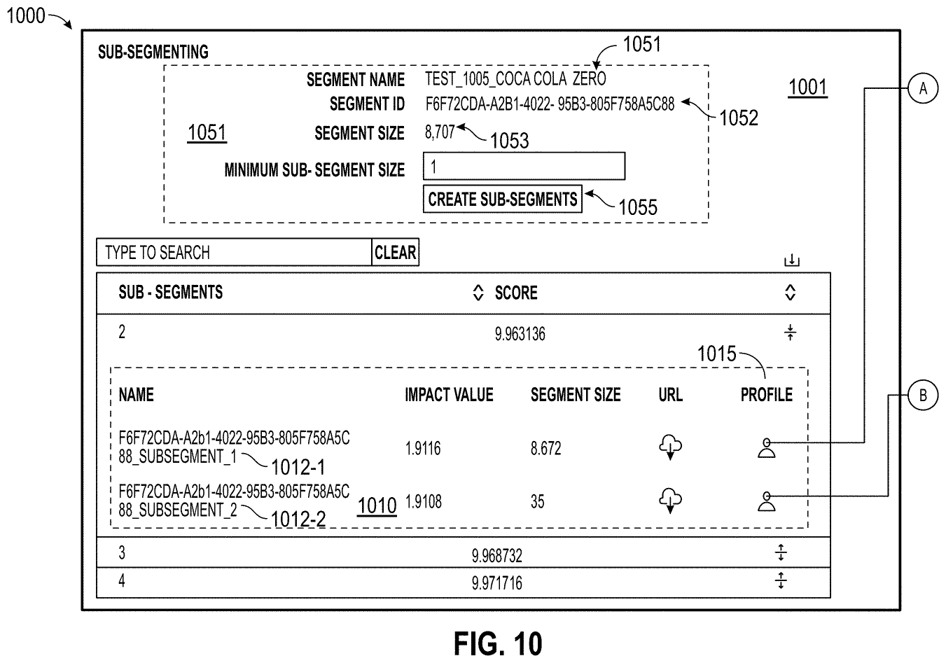

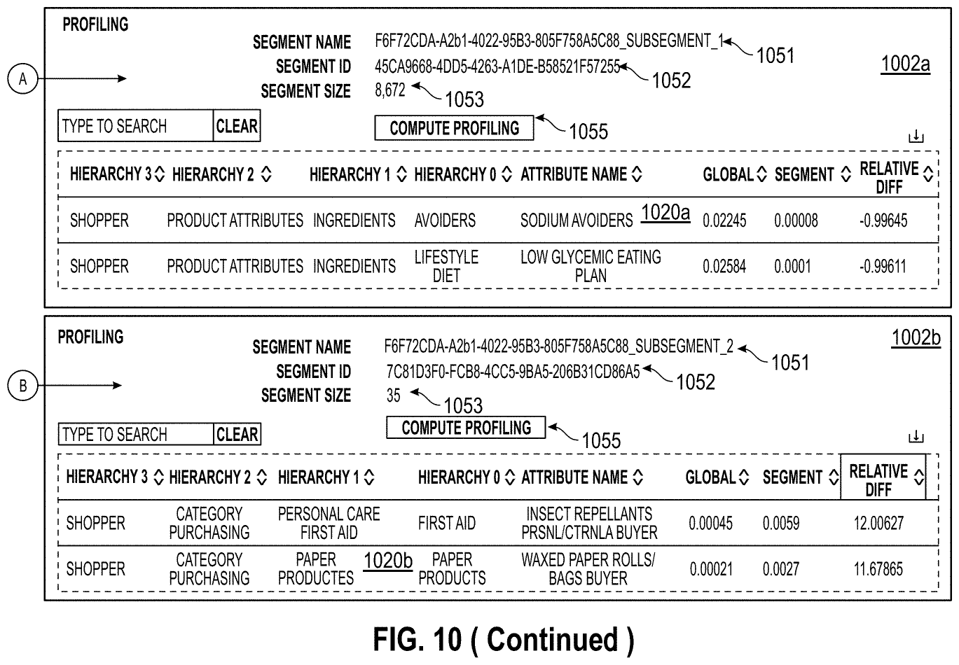

FIG. 10 illustrates a screenshot 1000 of a sub-segment profiling widget 1001 in an application to generate and handle consumer segments in a client device (e.g., application 222 and client devices 110 and 210), according to some embodiments. A segment metadata 1051 includes a segment name 1051, a segment ID 1052, and a segment size 1053. The user activates the sub-segment computation with button 1055. A listing 1010 illustrates sub-segments 1012-1 and 1012-2. The user may further select a sub-segment profile characterization 1015.

As a result of the user selecting sub-segment profile characterization 1015, a profile 1002a for sub-segment 1012-1 and a profile 1002b for sub-segment 1012-2 are displayed for the user (hereinafter, collectively referred to as “profiles 1002”). Profiles 1002 include lists of attributes 1020a and 1020b for each of sub-segments 1012-1 and 1012-2, respectively. The criteria and parameters in lists 1020a and 1020b (hereinafter, collectively referred to as “attribute lists 1020”) may include hierarchies, names and global, segment, and sub-segment weights, as described above (cf. segment attributes 912).

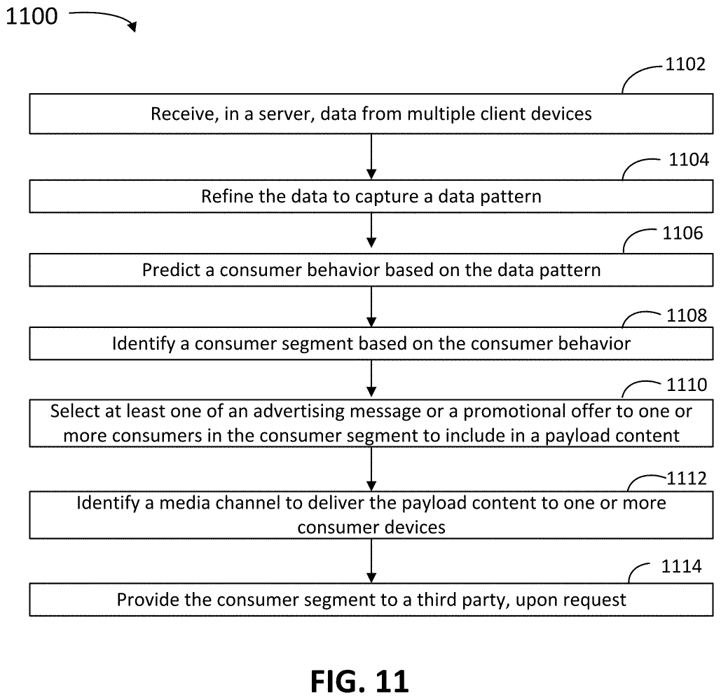

FIG. 11 is a flow chart illustrating steps in a method 1100 for providing a consumer segment based on raw data input from multiple consumers, according to some embodiments. Method 1100 may be performed at least partially by any one of the plurality of servers in collaboration with one or more client devices and databases, communicatively coupled through a network, as disclosed herein (cf. client devices 110 and 210, servers 130 and 230, databases 152 and 252, and networks 150 and 250). For example, at least some of the steps in method 1100 may be performed by one component in a system (cf. systems 10, 20, and 30), including a mobile device running code for a browser and an application to access a website for a consumer insight engine that processes logic to select consumer segments optimized for an advertising campaign (e.g., consumer insight engine 232). The system may also include a publisher SSP that requests advertisement bids from, and is registered with, a DSP server. In some embodiments, the consumer insight engine may include a data enrichment tool configured to receive and refine raw data, a target imputation tool, a consumer preference tool, and a behavior prediction tool, as disclosed herein (cf. data enrichment tool 240, targeting imputation tool 242, consumer preference tool 244, and behavior prediction tool 246). In some embodiments, one or more of the servers may also include an application layer to host and handle an application installed in a client device (e.g., application layer 215), so third party users may access the consumer insight engine. Accordingly, at least some of the steps in method 1100 may be performed by a processor executing commands stored in a memory of one of the servers or client devices, or accessible by at least one of the servers or client devices (e.g., processors 212 and memories 220). Further, in some embodiments, at least some of the steps in method 1100 may be performed overlapping in time, almost simultaneously, or in a different order from the order illustrated in method 1100. Moreover, a method consistent with some embodiments disclosed herein may include at least one, but not all, of the steps in method 1100.

Step 1102 includes receiving, in a server, a data from multiple client devices. The data may include raw purchasing data from each of multiple consumers at a POS in multiple retail stores distributed across a broad geographical area. The data may include historical data from multiple consumers over a long period of time.

Step 1104 includes refining the data to capture a data pattern.

Step 1106 includes predicting a consumer behavior based on the data pattern.

Step 1108 includes identifying a consumer segment based on the consumer behavior.

Step 1110 includes selecting at least one of an advertising message or a promotional offer to one or more consumers in the consumer segment to include in a payload content. In some embodiments, step 1110 includes selecting at least one of an offer, a promotion, or a recommendation, including a personalized coupon, to one or more consumers in the consumer segment.

Step 1112 includes identifying a media channel to deliver the payload content to one or more consumer devices.

Step 1114 includes providing the consumer segment to a third party, upon request.

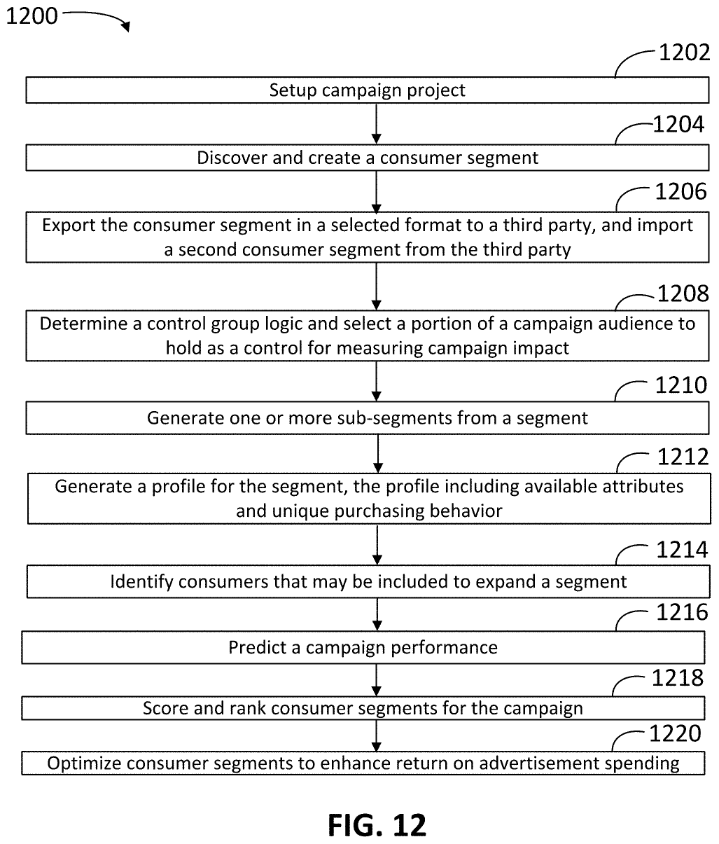

FIG. 12 is a flow chart illustrating steps in a method 1200 for providing an advertising campaign for a product or item for sale, according to some embodiments. Method 1200 may be performed at least partially by any one of the plurality of servers in collaboration with one or more client devices and databases, communicatively coupled through a network, as disclosed herein (cf. client devices 110 and 210, servers 130 and 230, databases 152 and 252, and networks 150 and 250). For example, at least some of the steps in method 1200 may be performed by one component in a system (cf. systems 10, 20, and 30), including a mobile device running code for a browser and an application to access a website for a consumer insight engine that processes logic to select consumer segments optimized for an advertising campaign (e.g., consumer insight engine 232). The system may also include a publisher SSP that requests advertisement bids from, and is registered with, a DSP server. In some embodiments, the consumer insight engine may include a data enrichment tool configured to receive and refine raw data, a target imputation tool, a consumer preference tool, and a behavior prediction tool, as disclosed herein (cf. data enrichment tool 240, targeting imputation tool 242, consumer preference tool 244, and behavior prediction tool 246). In some embodiments, one or more of the servers may also include an application layer to host and handle an application installed in a client device (e.g., application layer 215), so third party users may access the consumer insight engine. Accordingly, at least some of the steps in method 1200 may be performed by a processor executing commands stored in a memory of one of the servers or client devices, or accessible by at least one of the servers or client devices (e.g., processors 212 and memories 220). Further, in some embodiments, at least some of the steps in method 1200 may be performed overlapping in time, almost simultaneously, or in a different order from the order illustrated in method 1200. Moreover, a method consistent with some embodiments disclosed herein may include at least one, but not all, of the steps in method 1200.

Step 1202 includes setting up a campaign project.

Step 1204 includes discovering and creating a consumer segment.

Step 1206 includes exporting the consumer segment in a selected format to a third party, and importing a second consumer segment from the third party.

Step 1208 includes determining a control group logic and selecting a portion of a campaign audience to hold as a control for measuring campaign impact.

Step 1210 includes generating one or more sub-segments from a segment.

Step 1212 includes generating a profile for the segment, the profile including available attributes and unique purchasing behavior.

Step 1214 includes identifying consumers that may be included to expand a segment.

Step 1216 includes predicting a campaign performance

Step 1218 includes scoring and ranking consumer segments for the campaign.

Step 1220 includes optimizing consumer segments to enhance ROAS.

### Hardware Overview

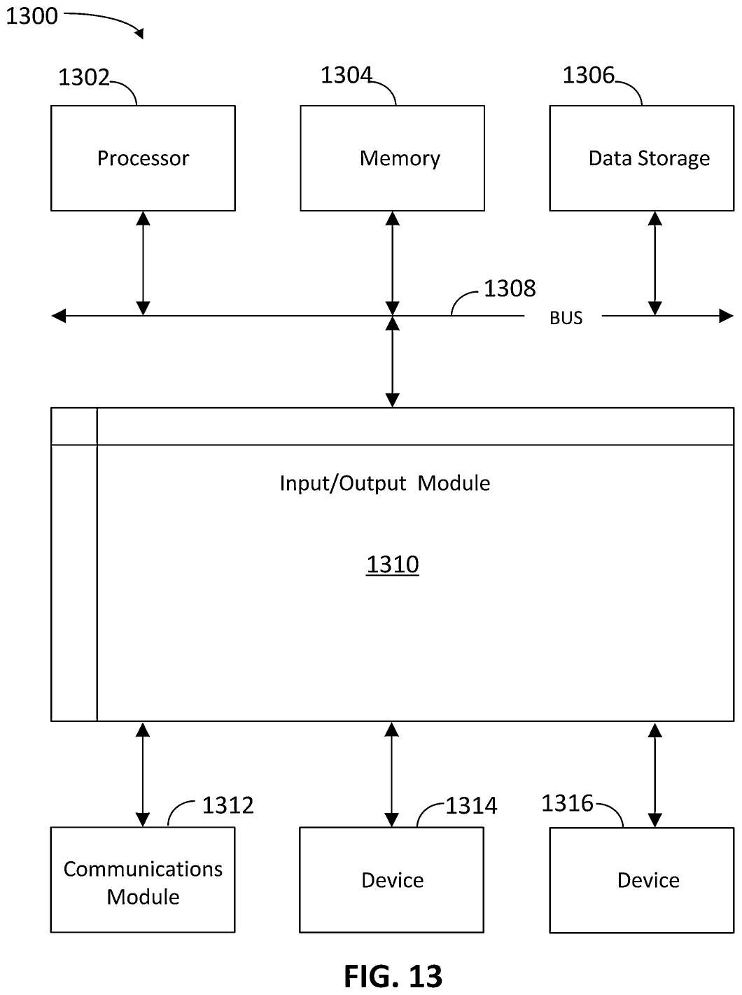

FIG. 13 is a block diagram illustrating an exemplary computer system 1300 with which the client device 110 and server 130 of FIGS. 1 and 2, and the methods of FIGS. 11 and 12 can be implemented. In certain aspects, the computer system 1300 may be implemented using hardware or a combination of software and hardware, either in a dedicated server, or integrated into another entity, or distributed across multiple entities.

Computer system 1300 (e.g., client device 110 and server 130) includes a bus 1308 or other communication mechanism for communicating information, and a processor 1302 (e.g., processors 212) coupled with bus 1308 for processing information. By way of example, the computer system 1300 may be implemented with one or more processors 1302. Processor 1302 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 1300 can include, in addition to hardware, code that creates an execution environment for the computer program in question, e.g., code that constitutes processor firmware, a protocol stack, a database management system, an operating system, or a combination of one or more of them stored in an included memory 1304 (e.g., memories 220), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled with bus 1308 for storing information and instructions to be executed by processor 1302. The processor 1302 and the memory 1304 can be supplemented by, or incorporated in, special purpose logic circuitry.

The instructions may be stored in the memory 1304 and implemented in one or more computer program products, e.g., one or more modules of computer program instructions encoded on a computer-readable medium for execution by, or to control the operation of, the computer system 1300, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 1304 may also be used for storing temporary variable or other intermediate information during execution of instructions to be executed by processor 1302.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and inter-coupled by a communication network. The processes and logic flows described in this specification can be performed by one or more programmable processors executing one or more computer programs to perform functions by operating on input data and generating output.

Computer system 1300 further includes a data storage device 1306 such as a magnetic disk or optical disk, coupled with bus 1308 for storing information and instructions. Computer system 1300 may be coupled via input/output module 1310 to various devices. Input/output module 1310 can be any input/output module. Exemplary input/output modules 1310 include data ports such as USB ports. The input/output module 1310 is configured to connect to a communications module 1312. Exemplary communications modules 1312 (e.g., communications modules 218) include networking interface cards, such as Ethernet cards and modems. In certain aspects, input/output module 1310 is configured to connect to a plurality of devices, such as an input device 1314 (e.g., input device 214) and/or an output device 1316 (e.g., output device 216). Exemplary input devices 1314 include a keyboard and a pointing device, e.g., a mouse or a trackball, by which a consumer can provide input to the computer system 1300. Other kinds of input devices 1314 can be used to provide for interaction with a consumer as well, such as a tactile input device, visual input device, audio input device, or brain-computer interface device. For example, feedback provided to the consumer can be any form of sensory feedback, e.g., visual feedback, auditory feedback, or tactile feedback; and input from the consumer can be received in any form, including acoustic, speech, tactile, or brain wave input. Exemplary output devices 1316 include display devices, such as an LCD (liquid crystal display) monitor, for displaying information to the consumer.

According to one aspect of the present disclosure, the client device 110 and server 130 can be implemented using a computer system 1300 in response to processor 1302 executing one or more sequences of one or more instructions contained in memory 1304. Such instructions may be read into memory 1304 from another machine-readable medium, such as data storage device 1306. Execution of the sequences of instructions contained in main memory 1304 causes processor 1302 to perform the process steps described herein. One or more processors in a multi-processing arrangement may also be employed to execute the sequences of instructions contained in memory 1304. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., a data server, or that includes a middleware component, e.g., an application server, or that includes a front end component, e.g., a client computer having a graphical consumer interface or a Web browser through which a consumer can interact with an implementation of the subject matter described in this specification, or any combination of one or more such back end, middleware, or front end components. The components of the system can be inter-coupled by any form or medium of digital data communication, e.g., a communication network. The communication network (e.g., networks 150 and 250) can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 1300 can include clients and servers. A client and server are generally remote from each other and typically interact through a communication network. The relationship of client and server arises by virtue of computer programs running on the respective computers and having a client-server relationship to each other. Computer system 1300 can be, for example, and without limitation, a desktop computer, laptop computer, or tablet computer. Computer system 1300 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 1302 for execution. Such a medium may take many forms, including, but not limited to, non-volatile media, volatile media, and transmission media. Non-volatile media include, for example, optical or magnetic disks, such as data storage device 1306. Volatile media include dynamic memory, such as memory 1304. Transmission media include coaxial cables, copper wire, and fiber optics, including the wires forming bus 1308. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially described as such, one or more features from a described combination can in some cases be excised from the combination, and the described combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

### RECITATION OF EMBODIMENTS

In a first (I) embodiment, a computer-implemented method includes receiving, in a server, a raw data from multiple consumer devices, and refining the raw data to capture a data pattern. The computer-implemented method also includes predicting a consumer behavior based on the data pattern, the consumer behavior defining one or more attributes, identifying a consumer segment based on the consumer behavior and a sharing of a one or more attributes among multiple consumers in the consumer segment. The computer-implemented method also includes selecting at least one of an advertising message or a promotional offer to one or more consumers in the consumer segment to include in a payload content, identifying a media channel to deliver the payload content to one or more consumer devices, and providing the consumer segment to a display in a client device, upon request.

In a second (II) embodiment, a system includes a data acquisition layer configured to test, standardize, partition, and format a raw data received by a server, and a data enrichment layer, configured to refine the raw data by transformation, feature computation, and training of an auxiliary model to capture a data pattern in the raw data. The system also includes a targeting imputation module configured to impute one or more consumer attributes to define a target audience and a consumer segment, a consumer preference module storing multiple consumer preferences for multiple products or brands and multiple consumer sensitivities for marketing impulses, a behavior prediction module configured to predict a consumer behavior based on the consumer preferences for products and the marketing impulses, and an application layer configured to provide a payload content to a consumer device, the payload content including a personalized advertisement or coupon for a selected product or brand based on the consumer behavior.

In a third (III) embodiment, a non-transitory, computer-readable medium storing instructions which, when executed by a processor, cause a computer to execute a method. The method includes receiving, in a server, a raw data from multiple consumer devices, refining the raw data to capture a data pattern, and predicting a consumer behavior based on the data pattern, the consumer behavior defining one or more attributes. The method also includes identifying a consumer segment based on the consumer behavior and a sharing of a one or more attributes among multiple consumers in the consumer segment, selecting at least one of an advertising message or promotional offer to one or more consumers in the consumer segment to include in a payload content, identifying a media channel to deliver the payload content to one or more consumer devices, and providing the consumer segment to a display in a client device, upon request.

Consistent with the present disclosure, the above embodiments I, II, and III may be combined with the following elements in any number, order, or permutation, as follows.

Element 1, wherein identifying the media channel includes selecting one of an in-store printer, a mobile video, a desktop display, or a third party advertisement, based on a type of the one or more consumer devices and a current location of the consumers. Element 2, further includes receiving, in the server, from a client device, a pre-selected universe of consumers and an impact goal for the payload content, wherein the pre-selected universe of consumers includes the consumer segment and is based on a product or brand identified in the payload content, and the impact goal includes a desired metric associating the consumer segment with the product or brand identified in the payload content. Element 3, further including determining a time duration of the promotional offer, promotion, or recommendation in the payload content based on the one or more attributes of the consumers in the consumer segment. Element 4, further including selecting a list of products or brands to be included in the payload content based on the one or more attributes of the consumers in the consumer segment. Element 5, further including: selecting a metric for the payload content, the metric associating a product or brand in the payload content to a consumer behavior, selecting a group of consumers to form a control group based on the one or more attributes, wherein the control group does not receive the payload content, determining an impact of the payload content on the consumer segment based on a comparison of a value of the metric for the control group with a value of the metric for the consumer segment, and ranking the consumer segment based on the impact of the payload content on the consumer segment. Element 6, further including generating a segment profile with a list of attributes and consumer behavior associated with a percentage of consumers in the consumer segment, and providing a graphical view of the segment profile to the display in the client device, the graphical view including an indicator of the percentage of consumers in a consumer universe associated with the list of attributes and consumer behavior. Element 7, further including determining an audience extension beyond the consumer segment for the payload content when a budget and a goal of a campaign for the payload content is not reachable within the consumer segment. Element 8, further including: predicting a campaign performance for the consumer segment based on a number of reachable users and a contact frequency of the payload content, and accounting for a deterioration of the campaign performance based on an audience extension. Element 9, further including receiving, in the server, a request from a use to split the consumer segment into a maximum number of sub-segments to increase an impact of the payload content, wherein a sub-segment includes one or more consumers from the consumer segment.

Element 10, wherein the targeting imputation module is further configured to select a group of consumers to form a control group based on the one or more consumer attributes, wherein the control group does not receive the payload content. Element 11, wherein the behavior prediction module is configured to evaluate a metric for the payload content associating the selected product or brand in the payload content to a measured consumer behavior. Element 12, wherein the behavior prediction module is configured to evaluate an impact of the payload content on the consumer segment based on a comparison of a metric value for a control group with a metric value for the consumer segment, and to rank the consumer segment based on the impact of the payload content on the consumer segment. Element 13, wherein the behavior prediction module is configured to generate a segment profile with a list of attributes and consumer behavior associated with a percentage of consumers in the consumer segment, and to provide a graphical view of the segment profile to a display in a client device, wherein the graphical view includes an indicator of the percentage of consumers in a consumer universe associated with the list of attributes and consumer behavior.

Element 14 wherein, in the method, identifying the media channel includes selecting one of an in-store printer, a mobile video, a desktop display, or a third party advertisement, based on a type of the one or more consumer devices and a current location of the consumers. Element 15, wherein the method further includes receiving, in the server, from a client device, a pre-selected universe of consumers and an impact goal for the payload content, wherein the pre-selected universe of consumers includes the consumer segment and is based on a product or brand identified in the payload content, and the impact goal includes a desired metric associating the consumer segment with the product or brand identified in the payload content. Element 16, wherein the method further includes determining a time duration of the promotional offer, promotion, or recommendation in the payload content based on the one or more attributes of the consumers in the consumer segment. Element 17, wherein the method further includes selecting a list of products or brands to be included in the payload content based on the one or more attributes of the consumers in the consumer segment.

.The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the described subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately described subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

1. A computer-implemented method, comprising:
receiving, in a server, a raw data from multiple consumer devices;
refining the raw data to capture a data pattern;
predicting a consumer behavior based on the data pattern, the consumer behavior defining one or more attributes;
identifying a consumer segment based on the consumer behavior and a sharing of a one or more attributes among multiple consumers in the consumer segment;
selecting at least one of an advertising message or a promotional offer to one or more consumers in the consumer segment to include in a payload content;
identifying a media channel to deliver the payload content to one or more consumer devices; and
providing the consumer segment to a display in a client device, upon request.

2. The computer-implemented method of claim 1, wherein identifying the media channel comprises selecting one of an in-store printer, a mobile video, a desktop display, or a third party advertisement, based on a type of the one or more consumer devices and a current location of the consumers.

3. The computer-implemented method of claim 1, further comprises receiving, in the server, from a client device, a pre-selected universe of consumers and an impact goal for the payload content, wherein the pre-selected universe of consumers includes the consumer segment and is based on a product or brand identified in the payload content, and the impact goal comprises a desired metric associating the consumer segment with the product or brand identified in the payload content.

4. The computer-implemented method of claim 1, further comprising determining a time duration of the promotional offer, promotion or recommendation in the payload content based on the one or more attributes of the consumers in the consumer segment.

5. The computer-implemented method of claim 1, further comprising selecting a list of products or brands to be included in the payload content based on the one or more attributes of the consumers in the consumer segment.

6. The computer-implemented method of claim 1, further comprising:
selecting a metric for the payload content, the metric associating a product or brand in the payload content to a consumer behavior;
selecting a group of consumers to form a control group based on the one or more attributes, wherein the control group does not receive the payload content;
determining an impact of the payload content on the consumer segment based on a comparison of a value of the metric for the control group with a value of the metric for the consumer segment;
and ranking the consumer segment based on the impact of the payload content on the consumer segment.

7. The computer-implemented method of claim 1, further comprising generating a segment profile with a list of attributes and consumer behavior associated with a percentage of consumers in the consumer segment, and providing a graphical view of the segment profile to the display in the client device, the graphical view including an indicator of the percentage of consumers in a consumer universe associated with the list of attributes and consumer behavior.

8. The computer-implemented method of claim 1, further comprising determining an audience extension beyond the consumer segment for the payload content when a budget and a goal of a campaign for the payload content is not reachable within the consumer segment.

9. The computer-implemented method of claim 1, further comprising:
predicting a campaign performance for the consumer segment based on a number of reachable users and a contact frequency of the payload content; and
accounting for a deterioration of the campaign performance based on an audience extension.

10. The computer-implemented method of claim 1, further comprising receiving, in the server, a request from a use to split the consumer segment into a maximum number of sub-segments to increase an impact of the payload content, wherein a sub-segment includes one or more consumers from the consumer segment.

11. A system, comprising:
a data acquisition layer configured to test, standardize, partition and format a raw data received by a server;
a data enrichment layer, configured to refine the raw data by transformation, feature computation, and training of an auxiliary model to capture a data pattern in the raw data;
a targeting imputation module configured to impute one or more consumer attributes to define a target audience and a consumer segment;
a consumer preference module storing multiple consumer preferences for multiple products or brands and multiple consumer sensitivities for marketing impulses;
a behavior prediction module configured to predict a consumer behavior based on the consumer preferences for products and the marketing impulses; and
an application layer configured to provide a payload content to a consumer device, the payload content including a personalized advertisement or coupon for a selected product or brand based on the consumer behavior.

12. The system of claim 11, wherein the targeting imputation module is further configured to select a group of consumers to form a control group based on the one or more consumer attributes, wherein the control group does not receive the payload content.

13. The system of claim 11, wherein the behavior prediction module is configured to evaluate a metric for the payload content associating the selected product or brand in the payload content to a measured consumer behavior.

14. The system of claim 11, wherein the behavior prediction module is configured to evaluate an impact of the payload content on the consumer segment based on a comparison of a metric value for a control group with a metric value for the consumer segment, and to rank the consumer segment based on the impact of the payload content on the consumer segment.

15. The system of claim 11, wherein the behavior prediction module is configured to generate a segment profile with a list of attributes and consumer behavior associated with a percentage of consumers in the consumer segment, and to provide a graphical view of the segment profile to a display in a client device, wherein the graphical view includes an indicator of the percentage of consumers in a consumer universe associated with the list of attributes and consumer behavior.

16. A non-transitory, computer readable medium storing instructions which, when executed by a processor, cause a computer to execute a method, the method comprising:
receiving, in a server, a raw data from multiple consumer devices;
refining the raw data to capture a data pattern;
predicting a consumer behavior based on the data pattern, the consumer behavior defining one or more attributes;
identifying a consumer segment based on the consumer behavior and a sharing of a one or more attributes among multiple consumers in the consumer segment;
selecting at least one of an advertising message or a promotional offer to one or more consumers in the consumer segment to include in a payload content;
identifying a media channel to deliver the payload content to one or more consumer devices; and
providing the consumer segment to a display in a client device, upon request.

17. The non-transitory, computer readable medium of claim 16 wherein, in the method, identifying the media channel comprises selecting one of an in-store printer, a mobile video, a desktop display, or a third party advertisement, based on a type of the one or more consumer devices and a current location of the consumers.

18. The non-transitory, computer readable medium of claim 16, wherein the method further comprises receiving, in the server, from a client device, a pre-selected universe of consumers and an impact goal for the payload content, wherein the pre-selected universe of consumers includes the consumer segment and is based on a product or brand identified in the payload content, and the impact goal comprises a desired metric associating the consumer segment with the product or brand identified in the payload content.

19. The non-transitory, computer readable medium of claim 16, wherein the method further comprises determining a time duration of the promotional offer, promotion or recommendation in the payload content based on the one or more attributes of the consumers in the consumer segment.

20. The non-transitory, computer readable medium of claim 16, wherein the method further comprises selecting a list of products or brands to be included in the payload content based on the one or more attributes of the consumers in the consumer segment.
